(19) United States
(12) Patent Application Publication
(10) Pub. No.: US 2026/0074518 A1
(43) Pub. Date: Mar. 12, 2026

(54) METHOD OF CONTROLLING A POWER SYSTEM

(71) Applicant: DELTA ELECTRONICS, INC., Taoyuan City (TW)

(72) Inventors: Yi-Kuan KE, Taoyuan City (TW); Chia-Ching LIN, Taoyuan City (TW); Yi-Kai TSENG, Taoyuan City (TW); Chih-Han KO, Taoyuan City (TW)

(21) Appl. No.: 19/070,496

(22) Filed: Mar. 4, 2025

(30) Foreign Application Priority Data
Sep. 10, 2024 (CN) 202411263870.8

(51) Int. Cl. H02J 3/14; H02J 3/00; H02J 3/32; H02J 3/40

(52) U.S. Cl. CPC H02J 3/14; H02J 3/001; H02J 3/32; H02J 3/40

(57) ABSTRACT

A Method of controlling a power system, comprising: determining whether a state of charge of an energy storage system lower than a first threshold value. When the state of charge is lower than the first threshold value, a power generator is activated and determining whether the power generator is abnormal. When the power generator is abnormal, supplying the power to loads by the energy storage system. When the power generator is normal, supplying the power to loads by the power generator. Determine whether the state of charge of the energy storage system is lower than the second threshold value, and reduce a part of loads when the state of charge is lower than the second threshold value.

### PRIORITY

This application claims priority to and the benefit of China Application Number 202411263870.8, filed Sep. 10, 2024, which is incorporated herein by reference in its entirety for all purposes.

### BACKGROUND

In the existing power system, when abnormality of the utility power system occurs, the microgrid will be disconnected to the utility power system. At this moment the energy storage system is switched from a current source to a voltage source to support the voltage level and frequency level of the bus in the microgrid, maintaining the other current source power supplying equipment and loads on the bus. When the utility power system is unable to recover immediately, the loads priorly rely on a renewable energy device. Secondly, if the renewable energy is insufficient, the loads rely on the energy reservoir. However, if the power generation of the renewable energy is lower than that of the load requires the state of charge of the energy storage system will decrease. Thus, it is necessary to further shed some of the power loops of the loads.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram illustrating a power system according to some embodiments of the disclosure.

FIG. 1B is a schematic diagram illustrating a power system according to some embodiments of the disclosure.

FIG. 2 is an operation flow chart diagram illustrating the operating method of a power system according to some embodiments of the disclosure.

FIG. 3 is an operating flow chart diagram illustrating the operation of determining the abnormality of a power generator according to some embodiments of the disclosure.

FIG. 4 is a schematic diagram illustrating a power system according to some embodiments of the disclosure.

FIG. 5 is a schematic diagram illustrating a power system according to some embodiments of the disclosure.

FIG. 6 is a schematic diagram illustrating a power system according to some embodiments of the disclosure.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The following disclosure provides a method of operating a power system, the power system includes a power generator and remote transfer switch, which can be applied to a continuous control technique of power supply, providing electricity continuously to multiple loads, and extending the time of power supplied. When the utility power system is abnormal, an energy storage system of the power system is switched from current source mode to voltage source mode to support the voltage and the frequency of the bus in the power system, and provide power to other power supplying systems and loads on the bus. When the state of charge of the energy storage system becomes insufficient, the energy storage system is no longer able to support the power and voltage stability of the power system, and thus it is required to disconnect (load-shedding) the loads step by step. The following disclosure combines the power generator and remote transfer switch technique to promote the power supplying control technique of the power system. In some embodiment, the power system can be embodied by a microgrid system.

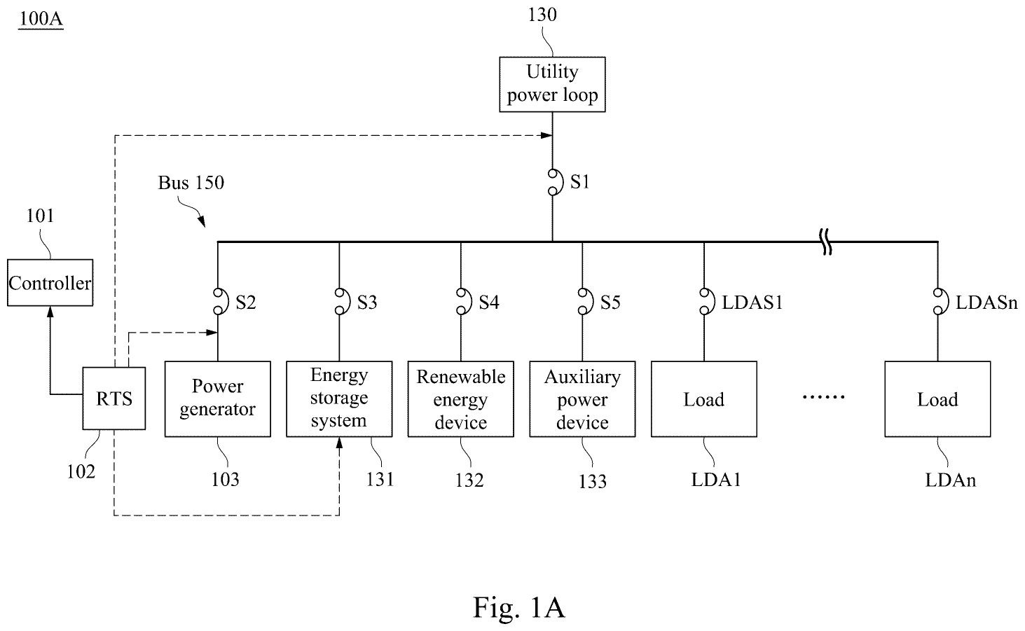

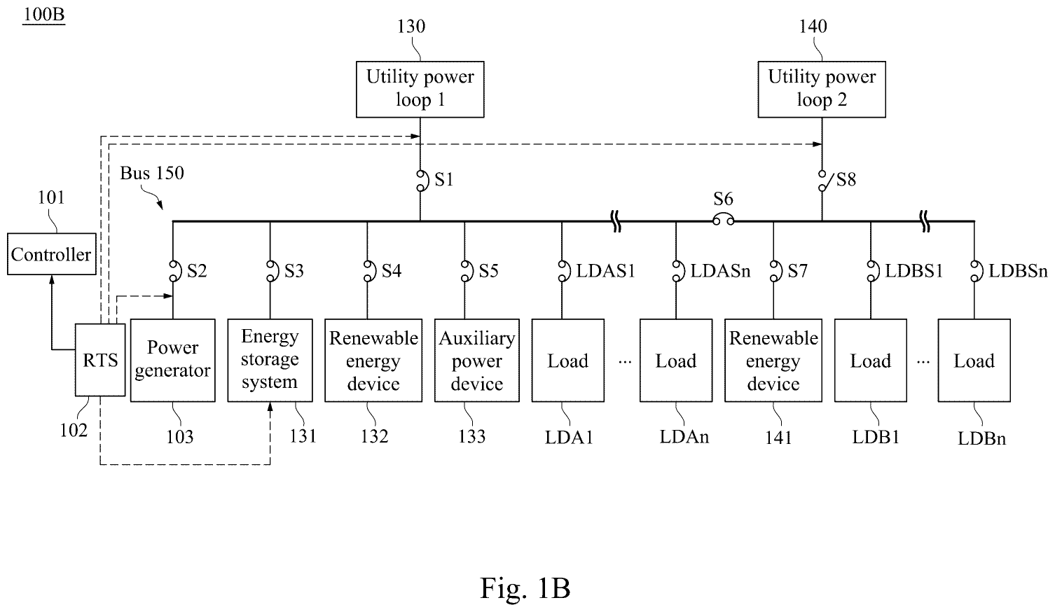

FIG. 1A is a schematic diagram illustrating a power system 100A according to some embodiments of the disclosure. The power system 100A comprises a controller 101, a remote transfer switch 102, a power generator 103, a utility power loop 130, an energy storage system 131, renewable energy device 132, auxiliary power device 133, a plurality of switches S1-S5, bus 150, a plurality of loads LDA1-LDAn, and a plurality of load switches LDAS1-LDASn.

As shown in FIG. 1A, the utility power loop 130 is connected to the bus 150 through the switch S1. The power generator 103 is connected to the bus 150 through the switch S2. The energy storage system 131 is connected to the bus 150 through the switch S3. The renewable energy device 132 is connected to the bus 150 through the switch S4. The auxiliary power device 133 is connected to the bus 150 through the switch S5. The loads LDA1-LDAn are connected to the bus 150 through the load switches LDAS1-LDASn, wherein n is a positive integer. In some embodiments, the renewable energy device 132 can be embodied by a solar panel.

In some embodiments, the remote transfer switch 102 is configured to detect voltages of the utility power loop 130, the power generator 103 and the energy storage system 131, and transfer the voltages information to the controller 101. The controller 101 is configured to control the closing and opening of the switches S1-S5 and load switches LDAS1-LDASn according to the voltages of the utility power loop 130, the power generator 103, and the energy storage system 131.

FIG. 1B is a schematic diagram illustrating a power system 100B according to some embodiments of the disclosure. The power system 100B is a variation of the power system 100A. The notation of the power system 100B adapts the notation of the power system 100A. For simplicity, the discussion will focus on the difference between the power system 100B and the power system 100A rather than the similarities.

Compared to the power system 100A, the power system 100B further includes a utility power loop 2 140, a renewable energy device 141, a plurality of loads LDB1-LDBn, a plurality of switches S6-S8, and a plurality of load switched LDBS1-LDBSn. The utility power loop 1 130 and the utility power loop 2 140 is connected to each other through the switch S6, and the utility power loop 2 140 is connected to the bus 150 through the switch S8.

In some embodiments, the remote transfer switch 102 further detects the voltage of the utility power loop 2 140, and transfers the voltage information to the controller 101. The controller 101 further controls the closing and opening of the switches S6-S8 and the load switches LDBS1-LDBSn according to the voltages of the utility power loop 2 140, the power generator 103 and the energy storage system 131.

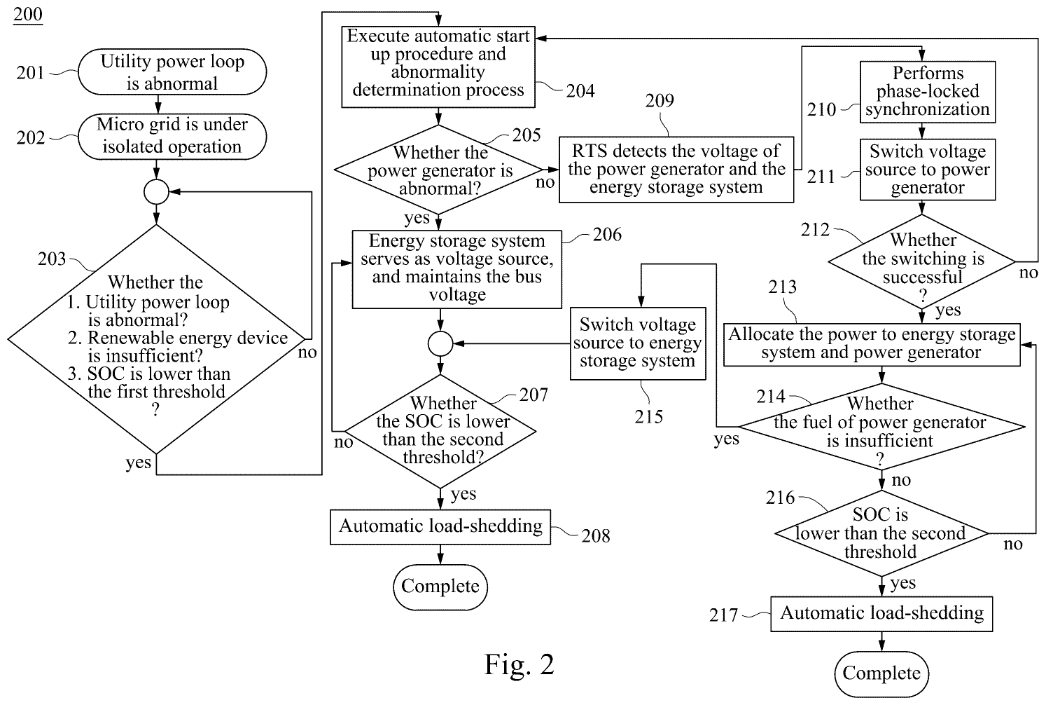

FIG. 2 is an operation flow chart diagram illustrating an operating method 200 of the power system 100A. The operating method 200 includes multiple operations 201-217.

Refer to FIG. 1A, FIG. 1B, and FIG. 2, operating method 200 can be executed on the power system 100A and/or the power system 100B. However, the disclosure is not limited to the embodiments herein. In some embodiments, the operating method 200 can be executed on a variety of power system. The following examples are illustrated with the operating method 200 of the power system 100A.

In the operation 201, the remote transfer switch 102 detects the voltage of the utility power loop 130 and transfers the voltage information to the controller 101 by a signal.

In some embodiments, when a voltage level of the utility power loop 130 is lower or greater than a default operating range of the voltage level of the utility power, the controller 101 determines the utility power loop 130 is abnormal. When the voltage level is within the default operating range of the voltage level of the utility power, the controller 101 determines the utility power loop 130 is normal.

When the utility power loop 130 is abnormal, the remote transfer switch 102 starts reading the voltages of the power generator 103 and the energy storage system 131, and the controller 101 opens the switch S1 that is connected to the utility power loop 130. When the utility power loop 130 is abnormal, the power system 100A continues to the operation 202 after the operation 201. When the utility power loop 130 is normal, the remote transfer switch 102 remains detecting the voltage of the utility power loop 130, and the controller 101 keeps the switch S1 closed, maintaining the connection between the utility power loop 130 and the bus 150, so as to let the utility power loop 130 remain providing power to the loads LDA1-LDAn.

In the operation 202, the power system 100A performs islanding operation. In some embodiments, the islanding operation represents that the power is provided to the loads LDA1-LDAn by the internal powering devices of the power system 100A in absence of the utility power loop. Specifically, when the utility power loop 130 is abnormal, the controller 101 opens the switch S1, and the power is provided to the loads LDA1-LDAn by the energy storage system 131 and the renewable energy device 132. The power system 100A continues to operation 203 after operation 202.

In the operation 203, the controller 101 is configured to remain determining whether the utility power loop is abnormal, the renewable energy device 132 is sufficient and the State of Charge (SOC) of the energy storage system 131 is lower than a first threshold value. In some embodiments, when the generation of the renewable energy device 132 is greater than the power of the loads LDA1-LDAn, the controller 101 determines the renewable energy device is sufficient. When the generation of the renewable energy device 132 is lower than the power of the loads LDA1-LDAn, the controller 101 determines the renewable energy device is insufficient.

In some embodiments, when the utility power loop 130 returns to normal, the remote transfer switch 102 detects the voltage of the utility power loop 130, and the controller 101 closes the switch S1 which connects the utility power loop 130 and the bus 150, so as to let the utility power loop 130 and the renewable energy device 132 provide power to the loads LDA1-LDAn.

In some embodiments, when the renewable energy device 132 is sufficient or the SOC of the energy storage system 131 is greater than the first threshold value, power is provided to the loads LDA1-LDAn by the renewable energy device 132 and the energy storage system 131, and the power system 100A repeats the operation 203.

In some embodiments, when the renewable energy device 132 is insufficient, and the SOC is lower than the first threshold value, the power system 100A continues to the operation 204 after the operation 203.

In the operation 204, the controller 101 executes the automatic startup procedure and abnormality determination process for the generator 103. The power system 100A continues to the operation 205 after the operation 204.

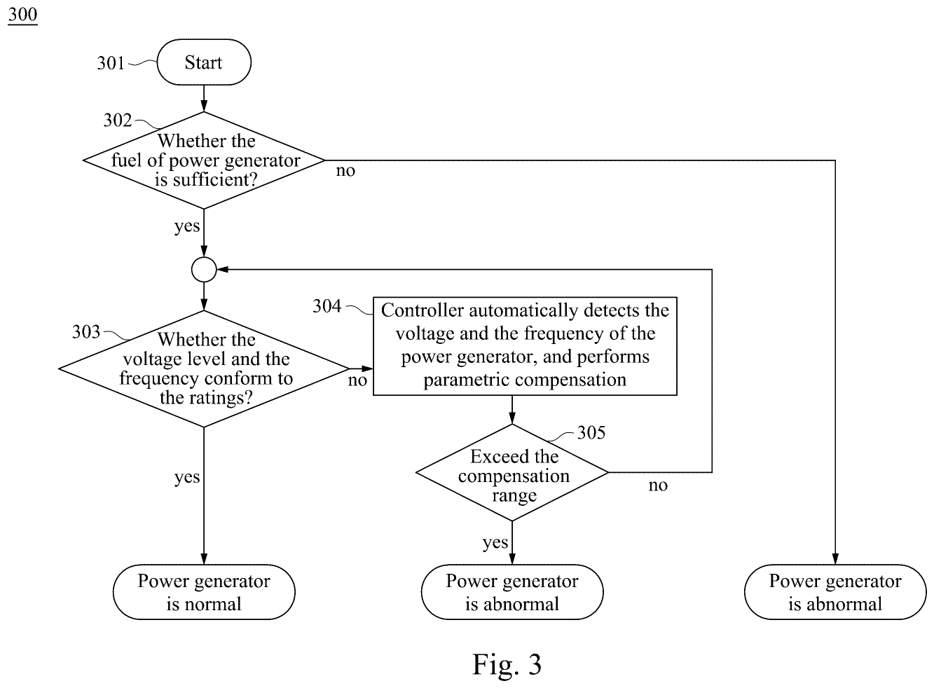

In the operation 205, the controller 101 determines whether the power generator 103 is abnormal. Operation details regarding the determination of whether the power generator 103 is abnormal will further be discussed in the following embodiments of FIG. 3. In some embodiments, when the controller 101 determines the power generator 103 is abnormal, the power system 100A continues to the operation 206 after the operation 205. When the controller 101 determines the power generator 103 is normal, the power system 100A continues to the operation 209 after the operation 205.

In the operation 206, the energy storage system 131 provides power to the loads LDA1-LDAn, and maintains the voltage level of the bus 150. The power system 100A continues to the operation 207 after the operation 206.

In the operation 207, the controller 101 determines whether the SOC of the energy storage system 131 is lower than a second threshold value. In some embodiments, when the SOC of the energy storage system 131 is lower than the second threshold value, the power system 100 continues to the operation 208 after the operation 207. When the SOC of the energy storage system 131 is greater than the second threshold value, the power system 100A repeats the operation 206 after the operation 207, and maintains the voltage level of the bus 150 with the energy storage system 131. In some embodiments, the second threshold value is lower than the first threshold value, and the first threshold value and the second threshold value are represented in terms of percentage of full charge of the energy storage system 131.

In the operation 208, in response to the SOC of the energy storage system 131 is lower than the second threshold value, the controller 101 performs automatic load-shedding to the loads LDA1-LDAn. Specifically, when the SOC of the energy storage system 131 is lower than the second threshold value, the controller 101 cuts off a part of the switches LDAS1-LDASn to disconnect the corresponding part of the loads LDA1-LDAn from the bus 150.

In some embodiments, the controller 101 selects a part of the loads LDA1-LDAn to perform automatic load-shedding according to a priority list. For example, under the circumstance that the priority of the load LDA1 is lower than the priority of the loads LDA2-LDAn, the controller 101 firstly sheds the load LDA1 in the operation 208, that is, opens the switch LDAS1. At this moment, the loads LDA2-LDAn remain online and are being powered by the energy storage system 131.

In the operation 209, in response to the controller 101 determines the power generator is abnormal, the remote transfer switch 102 detects the voltages of the power generator 103 and the energy storage system 131. The power system 100A continues to the operation 210 after the operation 209.

In the operation 210, the controller 101 performs a phase-locked synchronization to the power generator 103 and the energy storage system 131. Specifically, the phase-locked synchronization represents that the voltage and the frequency of the power generator 103 and the voltage and the frequency of the energy storage system 131 are synchronized by the controller 101. After the operation 210, the power generator 103 and the energy storage system 131 have the same voltage and frequency. The power system 100A continues to the operation 211 after the operation 210.

In the operation 211, the controller 101 switches the voltage source from the energy storage system 131 to the power generator 103, that is, the controller 101 closes the switch S2 which connects the power generator 103 to the bus 150. The power system 100A continues to the operation 212 after the operation 211.

In operation 212, the controller 101 determines whether the switching of voltage source is successful in operation 211. Specifically, when the voltage levels and frequencies of two terminals of the switch S2 is the same, the controller 101 determines the switching of voltage source is successful. When the voltage levels and frequencies of two terminals of the switch S2 is not the same, the controller 101 determines the switching of voltage source is not successful. When the controller 101 determines the switching of voltage source is not successful, the power system 100A repeats operation 204 after operation 212, and performs abnormality determination process to the power generator 103 by the controller 101. When the controller 101 determines the switching of voltage source is successful, the power system 100A continues to operation 213 after operation 212.

In operation 213, the controller 101 performs power allocation for the power generator 103 and the energy storage system 131. Specifically, the controller 101 calculates a power difference between the power provided by the renewable energy device 132 and the power required by the loads LDA1-LDAn, and the controller 101 controls the power generator 103 to provide the power that equals to the calculated power difference to the power system 100A. The power system continues to operation 214 after operation 213.

In some embodiment, when the power output provided by the renewable energy device 132 is lower than the power required by the loads LDA1-LDAn, power is provided by the power generator 103 so as to let the sum of the power provided by the renewable energy device 132 and the power generator 103 equals to the power required by the loads LDA1-LDAn. In some embodiments, when the power output provided by the renewable energy device 132 is lower than the power required by the loads LDA1-LDAn, power is provided by both of the power generator 103 and the energy storage system 131 so as to let the sum of the power provided by the renewable energy device 132, the power generator 103, and the power provided by the energy storage system 131 equals to the power required by the loads LDA1-LDAn. In some embodiments, when the power output provided by the renewable energy device 132 is greater than the power required by the loads LDA1-LDAn, the controller 101 controls the energy storage system 131 to absorb the power so that the power absorbed by the energy storage system 131 equals to a power difference between the power provided by the renewable energy device 132 and the power required by the loads LDA1-LDAn.

For example, when the power required by the loads LDA1-LDAn is 20 kW and the output power provided by the renewable energy device 132 is 8 kW, the controller 101 controls the power generator 103 to provide power 20 kW−8 kW=12 kW to the loads LDA1-LDAn. In another embodiments for example, when the power required by the loads LDA1-LDAn is 20 kW and the output power provided by the renewable energy device 132 is 8 kW, the controller 101 controls the energy storage system 131 to provide power 5 kW, the remaining power 20 kW−8 kW−5 kW=7 kW is provided by the power generator 103 to the loads LDA1-LDAn. In the other embodiments for example, when the power required by the loads LDA1-LDAn is 20 kW and the output power provided by the renewable energy device 132 is 25 kW, the controller 101 controls the energy storage system 131 to absorb power 25 kW−20 kW=5 kW from the bus 150 to offset the excessive power from the renewable energy device 132 so that the renewable energy device 132 will not reversely transfer power to the power generator 103.

In operation 214, the controller 101 determines whether the fuel of the power generator 103 is sufficient. Specifically, when the fuel of the power generator 103 is lower than a default fuel value, the controller 101 determines the fuel of the power generator is insufficient. When the fuel of the power generator 103 is greater than a default fuel value, the controller 101 determines the fuel of the power generator is sufficient. When the controller 101 determines the fuel of the power generator is insufficient, the power system 100A continues to operation 215 after operation 214. When the controller 101 determines the fuel of the power generator is sufficient, the power system 100A continues to operation 216 after operation 214.

In operation 215, the controller 101 switches the voltage source from the power generator 103 to the energy storage system 131, that is, the controller 101 opens the switch S2 which connects the power generator 103 to the bus 150. The power system 100A returns to operation 207 after operation 215.

In operation 216, the controller 101 determines whether the SOC of the energy storage system 131 is lower than the second threshold value. Specifically, when the power required by the loads LDA1-LDAn is greater than the power provided by the renewable energy device 132 and the power generator 103, and the SOC of the energy storage system 131 is lower than the second threshold value, the power system 100A continues to operation 217 after operation 216. When the power required by the loads LDA1-LDAn is greater than the power provided by the renewable energy device 132 and the power generator 103, yet the SOC of the energy storage system 131 is greater than the second threshold value, the power system 100A returns to operation 213 after operation 216.

For example, when the power provided by the renewable energy device 132 and the power generator 103 is lower than the power required by the loads LDA1-LDAn, a power is provided by the reservoir 131 to the loads LDA1-LDAn to meet the power requirement of the loads LDA1-LDAn.

In operation 217, in response to the SOC of the energy storage system 131 is lower than the second threshold value, the controller 101 initiates an automatic load-shedding process. Specifically, when the SOC of the energy storage system 131 is lower than the second threshold value, the controller 101 disconnects a portion of the switched loads LDAS1-LDASn from the bus 150, thereby reducing the corresponding part of the total loads LDA1-LDAn.

FIG. 3 is an operating flow chart diagram illustrating the method 300 of determining the abnormality of a power generator 103 according to some embodiments of the disclosure. As shown in FIG. 3, method 300 includes multiple operations 301-305.

Refer to FIG. 2 and FIG. 3, the method 300 is the method of determining the abnormality of the power generator 103 in operation 205. Specifically, after the controller 101 executes the automatic startup procedure, the controller 101 further executes method 300 to determine whether the power generator 103 is abnormal according to operation 301-305.

In operation 301, the controller 101 executes abnormality determination process. The power system 100A continues to operation 302 after operation 301.

In operation 302, the controller 101 determines whether the fuel of the power generator 103 is sufficient. In some embodiments, the controller 101 reads the fuel level of the fuel tank in the power generator 103. When the fuel level is greater than a limit value, the controller 101 determines the fuel of the power generator 103 is sufficient. When the fuel level is lower than a limit value, the controller 101 determines the fuel of the power generator 103 is insufficient.

In some embodiments, when the controller 101 determines the fuel of the power generator 103 is sufficient, the power system 100A continues to operation 303 after operation 302. When the controller 101 determines the fuel of the power generator 103 is insufficient, the power generator 103 is abnormal.

In operation 303, the controller 101 determines whether the voltage and the frequency of the power generator 103 conform to a rating value. Specifically, when the voltage level of the power generator 103 is within a range of an operative voltage rating, and the frequency of the power generator 103 is within a range of an operative frequency rating, the controller 101 determines the power generator 103 conforms to the rating, and determines the power generator 103 is normal. When the voltage level of the power generator 103 is greater or lower than the range of the operative voltage rating, or the frequency of the power generator 103 is greater or lower than the range of the operative frequency rating, the controller 101 determines the power generator 103 does not conform to the rating value, and the power system 100A continues to operation 304 after operation 303.

In operation 304, the controller 101 automatically detects the voltage and the frequency output from the power generator 103, and performs parametric compensation. In some embodiments, when the voltage level and the frequency are lower than the voltage rating and the frequency rating, the controller 101 performs parametric compensation according to the difference between the voltage level and the frequency and the corresponding ratings. Specifically, when the voltage level of the power generator 103 is lower than the voltage rating, the controller 101 adjusts the power generator 103 according to the difference between the voltage level and the voltage rating to increase the voltage. When the frequency of the power generator 103 is lower than the frequency rating, the controller 101 adjusts the power generator 103 according to the difference between the frequency and the frequency rating to increase the frequency.

For example, when the voltage level and the frequency of the power generator 103 are 470V and 58 Hz respectively, and the corresponding ratings are 480V and 60 Hz, the controller 101 compensates the voltage level from 470V to 480V and the frequency from 58 Hz to 60 Hz. The power system 100A continues to operation 305 after operation 304.

In operation 305, the controller 101 determines whether the voltage level and the frequency, compared to the corresponding ratings, are lower than the compensation range. Specifically, the controller 101 can limitedly compensate the insufficient voltage and frequency to the power generator 103, that is, the controller 101 adjusts the voltage and frequency of the power generator 103 within a limited compensation range to correspondingly increase the voltage level and frequency to the voltage rating and frequency rating.

In some embodiments, when the voltage of the power generator 103 cannot be adjusted to the voltage rating, or when the frequency of the power generator 103 cannot be adjusted to the frequency rating, the controller 101 determines the power generator 103 is abnormal. Specifically, when a difference between the voltage level of the power generator 103 and the voltage rating, and a difference between the frequency of the power generator 103 and the frequency rating, are greater than the corresponding compensation range, the controller 101 determines the power generator 103 is abnormal. When a difference between the voltage level of the power generator 103 and the voltage rating, and a difference between the frequency of the power generator 103 and the frequency rating, are lower than or equal to the corresponding compensation range, the controller 101 determines the power generator 103 is normal. The power system 100A continues to operation 303 after operation 305.

In some embodiments, the method 300 of determining the abnormality of the power generator 103 can be adapted to the power system 100A in FIG. 1A, the power system 100B in FIG. 1B, or other similar power system, but the disclosure is not limited to these power systems.

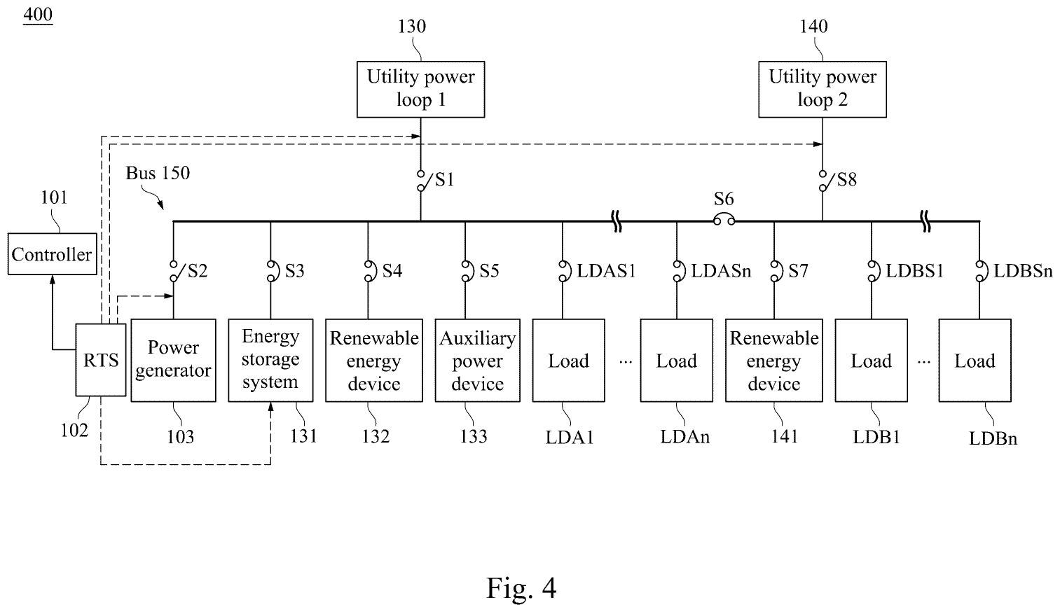

FIG. 4 is a schematic diagram illustrating a power system 400 according to some embodiments of the disclosure. Refer to FIG. 1B and FIG. 4; the power system 400 is another embodiment of power system 100B.

In the embodiment shown in FIG. 4, the power generator 103 of the power system 400 is abnormal, and the power system 400 is under an isolated operation status, and the energy storage system 131 serves as a voltage source. In some embodiments, the power system 400 can be corresponded to a schematic diagram of operation 203 in FIG. 2. When the controller 101 determines at least one of the renewable energy devices 132 and/or 141 are sufficient or the SOC of the energy storage system 131 is greater than the first threshold value, the loads LDA1-LDAn and the loads LDB1-LDBn of the power system 400 are powered by the energy storage system 131 and the renewable energy devices 132 and/or 141. In some embodiments, the power system 400 can be corresponded to a schematic diagram of operation 206 in FIG. 2. When the power generator 103 of the power system 400 is abnormal, and the controller 101 determines the renewable energy devices 132 and 141 are insufficient or the SOC of the energy storage system 131 is lower than the first threshold value, the loads LDA1-LDAn and the loads LDB1-LDBn of the power system 400 are powered by the energy storage system 131, and the energy storage system 131 maintains the systematic voltage of the power system 400.

Specifically, in the power system 400, when the controller 101 determines the utility power loop 1 130 and the utility power loop 2 140 are abnormal, the controller 101 opens the switches S1 and S8 which connect the utility power loop 1 130 and the utility power loop 2 to the bus 150 respectively. In some embodiments, when the controller 101 further determines the renewable energy devices 132 and/or 141 are sufficient or the SOC of the energy storage system 131 is greater than the first threshold value, the energy storage system 131 serves as a voltage source configured to maintain the voltage level of the bus 150, and the loads LDA1-LDAn and the loads LDB1-LDBn are powered by both of the energy storage system 131 and the renewable energy device 132. In some other embodiments, when the controller 101 further determines the renewable energy devices 132 and/or 141 are insufficient or the SOC of the energy storage system 131 is lower than the first threshold value, and the power generator 103 is determined to be abnormal, the energy storage system 131 serves as a voltage source configured to maintain the voltage level of the bus 150, and the loads LDA1-LDAn and the loads LDB1-LDBn are powered by both of the renewable energy devices 132 and/or 141 and the energy storage system 131.

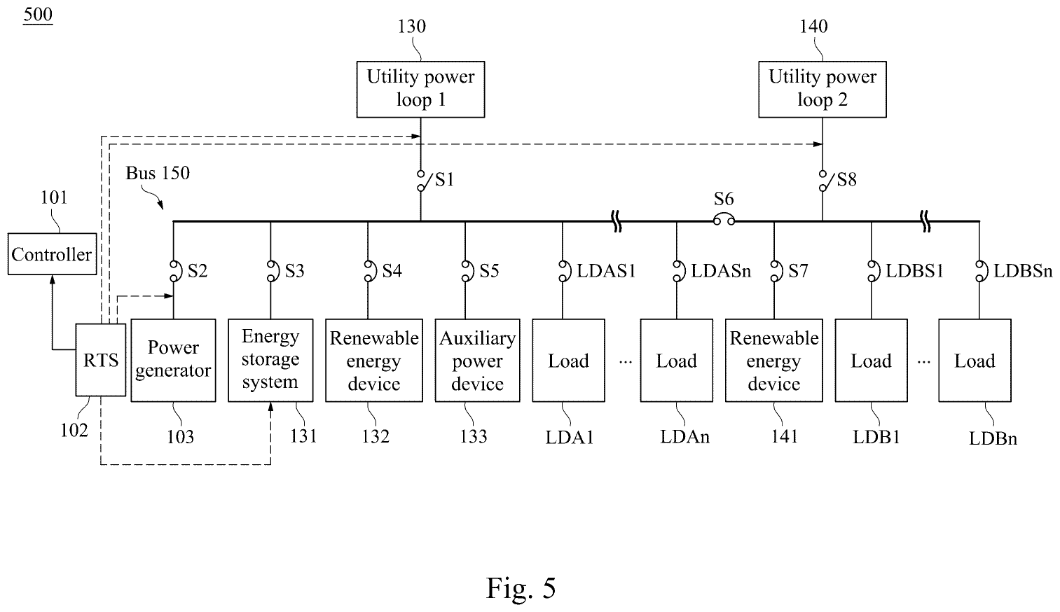

FIG. 5 is a schematic diagram illustrating a power system 500 according to some embodiments of the disclosure. Refer to FIG. 1B and FIG. 5; the power system 500 is another embodiment of power system 100B.

In the embodiment shown in FIG. 5, the power system 500 is under an isolated operation status, and the power generator 103 serves as a voltage source. In some embodiments, the power system 500 can be corresponded to a schematic diagram of operation 203 in FIG. 2. When the controller 101 further determines the renewable energy devices 132 and/or 141 are insufficient or the SOC of the energy storage system 131 is lower than the first threshold value, and in operation 205 the controller 101 further determines the power generator 103 is normal, the loads LDA1-LDAn and the loads LDB1-LDBn are powered by the renewable energy devices 132 and 141, the energy storage system 131, and the power generator 103. Additionally, the power generator 103 is configured to maintain the voltage level of the bus 150.

Specifically, in the power system 500, when the controller 101 determines the utility power loop 1 130 and the utility power loop 2 140 are abnormal, the controller 101 opens the switches S1 and S8 which connect the utility power loop 1 130 and the utility power loop 2 to the bus 150 respectively. In some embodiments, when the controller 101 further determines the renewable energy devices 132 and/or 141 are insufficient or the SOC of the energy storage system 131 is lower than the first threshold value, and the controller 101 determines the power generator 103 is normal, the power generator 103 serves as a voltage source configured to maintain the voltage level of the bus 150, and the loads LDA1-LDAn and the loads LDB1-LDBn are powered by the power generator 103, the renewable energy devices 132 and 141, and the energy storage system 131.

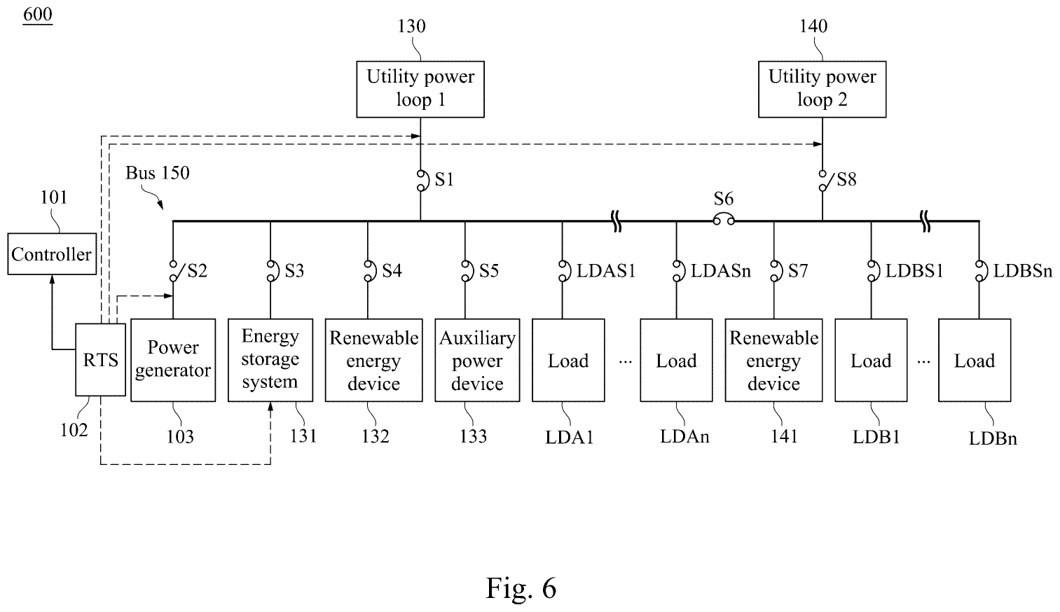

FIG. 6 is a schematic diagram illustrating a power system 600 according to some embodiments of the disclosure. Refer to FIG. 1B and FIG. 6; the power system 600 is another embodiment of power system 100B.

In the embodiment shown in FIG. 6, the power system 600 is under a jointed operation status and the utility power loop 1 130 serves as a voltage source. In some embodiments, as shown in FIG. 6, the controller 101 determines the utility power loop 2 140 is abnormal, and the switch S8 is opened. On the contrary, the controller 101 determines the utility power loop 1 130 is normal, and thus, the utility power loop 1 130 serves as a voltage source configured to maintain the voltage level of the bus 150. When the utility power loop 1 130 is determined to be normal, the loads LDA1-LDAn and the loads LDB1-LDBn are powered by the utility power loop 1 130 and the renewable energy devices 132 and 141. Additionally, the switch S2 which connects the power generator 103 to the bus 150 remains opened.

Specifically, in power system 600, when the controller 101 determines the utility power loop 1 130 is normal, and the utility power loop 2 140 is abnormal, the controller 101 opens the switch S8 which connects the utility power loop 2 140 to the bus 150, and the utility power loop 1 130 serves as a voltage source configured to maintain the voltage level of the bus 150.

In some embodiments, when the renewable energy devices 132 and/or 141 are sufficient or the SOC of the energy storage system 131 is greater than the first threshold value, the loads LDA1-LDAn and the loads LDB1-LDBn are powered by all of the energy storage system 131, the renewable energy devices 132 and/or 141, and the utility power loop 1 130.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of controlling a power system, comprising:
determining whether a state of charge of an energy storage system is lower than a first threshold value;
when the state of charge is lower than the first threshold value, a power generator activating and determining whether the power generator is abnormal;
when the power generator is normal, supplying the power to loads by the power generator;
when the power generator is abnormal, supplying the power to the loads by the energy storage system, and determining whether the state of charge of the energy storage system is lower than a second threshold value; and
reducing a part of the loads when the state of charge is lower than the second threshold value.

2. The method of claim 1, wherein determining whether the power generator is abnormal including:
determining whether a fuel of the power generator is sufficient, wherein
when the fuel of the power generator is not sufficient, determining the power generator to be abnormal.

3. The method of claim 2, wherein determining whether the power generator is abnormal further including:
when the fuel of the power generator is sufficient, determining whether a voltage of the power generator conforms to a voltage rating and a frequency of the power generator conforms to a frequency rating; and
when the voltage is lower than the voltage rating, adjusting the power generator according to a voltage difference between the voltage and the voltage rating to increase the voltage.

4. The method of claim 3, wherein determining whether the power generator is abnormal further including:
when the frequency is lower than the frequency rating, adjusting the power generator according to a frequency difference between the frequency and the frequency rating to increase the frequency.

5. The method of claim 4, wherein determining whether the power generator is abnormal further including:
when the voltage cannot be adjusted to the voltage rating, or the frequency cannot be adjusted to the frequency rating, determining the power generator is abnormal.

6. The method of claim 1, further including:
when the power generator is determined to be normal, calculating a power difference between a first power and a second power according to the first power provided by a renewable energy device through a bus to the plurality of loads and the second power the plurality of loads required; and
when the first power is greater than the second power, absorbing the power difference by the energy storage system from the bus.

7. The method of claim 6, wherein determining whether the power generator is abnormal further including:
when the second power is greater than the first power, supplying the power difference to the plurality of loads by the power generator through the bus.

8. The method of claim 1, wherein the first threshold value is greater than the second threshold value.

9. The method of claim 1, further including:
when the state of charge is lower than the first threshold value, and the power generator is determined to be abnormal, opening a switch of the power generator and determining whether the state of charge is lower than the second threshold value; and
when the state of charge is greater than the second threshold value, providing a power to the plurality of loads by the energy storage system.

10. The method of claim 1, further including:
when the state of charge is lower than the first threshold value, and the power generator is determined to be normal, synchronizing a voltage and a frequency of the power generator to a voltage and a frequency of the energy storage system.

11. A power system, comprising:
an energy storage system connecting to a bus, configured to power a plurality of loads, and the energy storage system including a state of charge;
a power generator connecting to the bus configured to power the plurality of loads;
a plurality of switches connecting the plurality of loads to the bus, and
a controller configured to determine whether the state of charge of the energy storage system is lower than a first threshold value, and whether the power generator is abnormal,
wherein when the state of charge is lower than the first threshold value, the controller activates the power generator,
when the power generator is normal, the power generator supplies the power to the plurality of loads,
when the power generator is abnormal, the energy storage system supplies the power to the loads, and the controller determines whether the state of charge of the energy storage system is lower than a second threshold value, and
when the state of charge is lower than the second threshold value, the controller reduces a part of the plurality of loads by the switches.

12. The power system of claim 11, wherein determining whether the power generator is abnormal including:
determining whether a fuel of the power generator is sufficient, wherein
when the fuel of the power generator is not sufficient, determining the power generator to be abnormal.

13. The power system of claim 12, wherein determining whether the power generator is abnormal further including:
when the fuel of the power generator is sufficient, determining whether a voltage of the power generator conforms to a voltage rating and a frequency of the power generator conforms to a frequency rating; and
when the voltage is lower than the voltage rating, adjusting the power generator according to a voltage difference between the voltage and the voltage rating to increase the voltage.

14. The power system of claim 13, wherein determining whether the power generator is abnormal further including:
when the frequency is lower than the frequency rating, adjusting the power generator according to a frequency difference between the frequency and the frequency rating to increase the frequency.

15. The power system of claim 14, wherein determining whether the power generator is abnormal further including:
when the voltage cannot be adjusted to the voltage rating, or the frequency cannot be adjusted to the frequency rating, determining the power generator is abnormal.

16. The power system of claim 11, wherein determining whether the power generator is abnormal further including:
when the power generator is determined to be normal, calculating a power difference between a first power and a second power according to the first power provided by a renewable energy device through the bus to the plurality of loads and the second power the plurality of loads required; and
when the first power is greater than the second power, absorbing the power difference by the energy storage system from the bus.

17. The power system of claim 16, wherein determining whether the power generator is abnormal further including:
When the second power is greater than the first power, supplying the power difference to the plurality of loads by the power generator through the bus.

18. The power system of claim 11, wherein the first threshold value is greater than the second threshold value.

19. The power system of claim 11, wherein
when the state of charge is lower than the first threshold value, and the power generator is determined to be abnormal, opening a switch of the power generator and determining whether the state of charge is lower than the second threshold value by the controller,
wherein when the state of charge is greater than the second threshold value, providing a power to the plurality of loads by the energy storage system.

20. The power system of claim 11, wherein
when the state of charge is lower than the first threshold value, and the power generator is determined to be normal, synchronizing a voltage and a frequency of the power generator to a voltage and a frequency of the energy storage system by the controller.
